(19) United States
(12) Patent Application Publication
(10) Pub. No.: US 2023/0140071 A1
(43) Pub. Date: May 4, 2023

(54) FISH BLEEDING METHOD, FISH PRODUCTION METHOD AFTER BLEEDING TREATMENT, FISH AFTER BLEEDING TREATMENT AND FISH BLEEDING APPARATUS

(71) Applicant: Hamasui Co., Ltd., Minamiuwagun (JP)

(72) Inventor: Yoshiyuki HAMADA, Minamiuwagun (JP)

(21) Appl. No.: 18/146,461

(22) Filed: Dec. 27, 2022

Related U.S. Application Data
(63) Continuation of application No. PCT/JP2022/016183, filed on Mar. 30, 2022.

(30) Foreign Application Priority Data
Sep. 21, 2021 (JP) 2021-152758

(51) Int. Cl. A22C 25/14

(52) U.S. Cl. CPC A22C 25/14

(57) ABSTRACT

A fish bleeding method includes an insertion step of inserting a tubular device, which is a member in a tubular shape, into a blood vessel system of a fish, and an injection step of injecting an injection liquid, which is a liquid containing fine bubbles, into the blood vessel system of the fish through the tubular device that is inserted in the insertion step.

### CROSS REFERENCE TO RELATED APPLICATIONS

This application is a continuation of PCT application No. PCT/JP2022/016183 filed on Mar. 30, 2022, and which claims priority to JP2021-152758 filed on Sep. 21, 2021, the disclosures of which are incorporated herein by reference.

### TECHNOLOGY FIELD

The present invention relates to a fish bleeding method by injecting fluid into a blood vessel system, a fish production method after bleeding treatment, a fish after bleeding treatment and a fish bleeding apparatus.

### BACKGROUND

Fish blood is a cause of the fishy smell of fish and one of the causes of deteriorating the freshness of fish. Therefore, removing the blood from a fish body (blood extraction) is a very important task for maintaining the quality of fish.

As a general bleeding method, a method is known in which gills and/or caudal fins are cut and the blood is drained from the blood vessels. However, with this method, blood remains in the blood vessel system, making it difficult to remove all the blood.

To address such a problem, for example, Patent Document 1 discloses a method of removing blood (or bleeding) by injecting fluid into the blood vessel system. According to this method, since the blood in the blood vessel system is replaced with another liquid, the blood is removed more reliably than the above-described conventional bleeding method that simply lets the blood flow out from the cut blood vessel.

### RELATED ART

### Patent Document(s)

[Patent Doc. 1] JP Laid-Open Patent Application Publication

### Objectives to be Solved

However, the method disclosed in Patent Document 1 has a problem that the “Umami (flavor, deliciousness)” of fish is weakened.

The present invention has been made in view of such conventional problems. One of the objectives of the present invention is to provide a fish bleeding method that suppresses the odor of fish without weakening the Umami of fish. Another objective of the present invention is to provide a fish production method for producing fish to which the fish bleeding treatment is applied, a fish after the bleeding treatment, and a fish bleeding apparatus.

### SUMMARY

Regarding the first aspect of the present invention with respect to a fish bleeding method, the method includes an insertion step of inserting a tubular device, which is a member in a tubular shape, into a blood vessel system of a fish, and an injection step of injecting an injection liquid, which is a liquid containing fine bubbles, into the blood vessel system of the fish through the tubular device that is inserted in the insertion step. According to the above configuration, it is possible to more reliably remove blood while suppressing damage to muscle tissues of the fish by using the injection liquid, which is a liquid containing fine bubbles. As a result, the odor of the fish is suppressed without weakening the Umami of the fish.

Regarding another aspect of the present invention with respect to the fish bleeding method, the method further includes a fine bubble generation step of generating the injection liquid wherein the fine bubbles are saturated in the injection liquid during the fine bubble generation step.

Regarding another aspect of the present invention with respect to the fish bleeding method, a gas that is used to form the fine bubbles is any one of nitrogen gas, carbon dioxide gas, and a mixture of nitrogen gas and carbon dioxide gas. According to the above configuration, it is possible to prevent lipid oxidation of fish meat and transformation of myoglobin to metmyoglobin due to gas components contained in the injection liquid.

Regarding the second aspect of the present invention with respect to the fish bleeding method, the method further includes a curing step of allowing the fish to swim in a curing liquid, which is a liquid in which oxygen is dissolved, before the insertion step. According to the above configuration, by increasing the ATP possessed by the fish, the Umami of the fish increases. In addition, a fish that has been relaxed in the curing step has their blood vessels widened, making it easier for blood to flow. As a result, the fish blood is removed more efficiently.

Regarding the third aspect of the present invention with respect to a fish production method for producing a fish after a fish bleeding treatment, the method includes an insertion step of inserting a tubular device, which is a member in a tubular shape, into a blood vessel system of a fish, and an injection step of injecting an injection liquid, which is a liquid containing fine bubbles, into the blood vessel system of the fish through the tubular device that is inserted in the insertion step.

Regarding the fourth aspect of the present invention with respect to the fish production method, the method further includes a curing step of allowing the fish to swim in a curing liquid, which is a liquid in which oxygen is dissolved, before the insertion step.

Regarding the fifth aspect of the present invention with respect to a fish that is processed by the fish bleeding treatment, the fish has a puncture mark that is formed by inserting a tubular device, which is a member in a tubular shape, into a blood vessel system of the fish, blood in the blood vessel system is replaced with an injection fluid that contains fine bubbles such that an inside of the blood vessel system is filled with the injection fluid. By the above-described fish treated by the method, damage to muscle tissues is suppressed, and the fish from which blood has been more reliably removed is provided. That is, a fish with increased Umami and less odor is provided.

Regarding the six aspect of the present invention with respect to the fish bleeding apparatus, the fish bleeding apparatus includes a tubular device, which is a member in a tubular shape, that is configured to be inserted into a blood vessel system of a fish, a container connection part that is configured to directly or indirectly connect a container for containing liquid to the tubular device, a fine bubble generation part that generates an injection liquid, which is a liquid containing fine bubbles, from the liquid contained in the container, a pressure unit that applies pressure to the injection liquid in the container such that the injection liquid is forced into the blood vessel system of the fish through the tubular device. According to the above configuration, it is possible to more reliably remove blood while suppressing damage to the muscle tissues of the fish by using the injection liquid, which is a liquid containing fine bubbles. Because the apparatus is potable, the bleeding treatment is performed at a spot where the fish is caught.

Regarding the seven aspect of the present invention with respect to the fish bleeding apparatus, the container connection part has a female screw that is mate with a male screw provided on a mouth of a polyethylene terephthalate (PET) bottle.

According to the above configuration, it is possible to easily remove blood from fish by using a general PET bottle, which is sold at a public market.

### BRIEF DESCRIPTION OF THE DRAWINGS

FIG. 1 is a flow chart of a bleeding method for according to the present invention;

FIG. 2 is a schematic diagram of a yellowtail to explain the bleeding method for fish.

FIG. 3 is a schematic diagram of a yellowtail to explain the bleeding method for fish.

FIG. 4 is a schematic diagram of a yellowtail to explain the bleeding method for fish.

FIG. 5 is a schematic diagram of a yellowtail to explain the bleeding method for fish.

FIG. 6 is a table showing results of a sensory test on the degree of odor.

FIG. 7 is a table showing results of a sensory test on the degree of Umami.

FIG. 8 is an explanatory diagram of the mechanism of the bleeding method for fish according to the present invention to suppress the odor of fish.

FIG. 9 is an explanatory diagram of the mechanism of the bleeding method for fish according to the present invention not to weaken the Umami of fish.

FIG. 10 is a schematic diagram of a fish bleeding apparatus according to the present invention.

### DETAILED DESCRIPTIONS OF THE PREFERRED EMBODIMENT(S)

Hereinafter, embodiments of the present invention are described with reference to the drawings. The embodiments shown below exemplify a fish bleeding method, a fish production method after bleeding treatment, a fish to which the bleeding treatment has been applied (or fish after bleeding treatment), and a fish bleeding apparatus to embody the technical idea/concept of the present invention. The claimed boundary of the present invention is not limited to the fish bleeding method, the fish production method after bleeding treatment, the fish after bleeding treatment, and the fish bleeding apparatus. In addition, this specification does not specify the members recited in the claims as the members of the embodiment(s). The dimensions, materials, shapes, relative arrangements, etc. of the components described in the embodiments are not limited to the claimed elements of the present invention, not intended to do so unless otherwise specifically limited. The descriptions in the specification are merely illustrative examples of the claimed invention. Note that the sizes and positional relationships of members shown in each drawing may be exaggerated for clarity of explanation. Furthermore, in the following description, the same names and symbols indicate the same or similar members, and detailed description thereof will be occasionally omitted. Furthermore, each of the elements constituting the present invention may be configured with the same member so that a single member may serve as a plurality of elements, vice versa, a function of one member may be performed by a plurality of members or also may be realized by sharing several members.

### [Fish Bleeding Method]

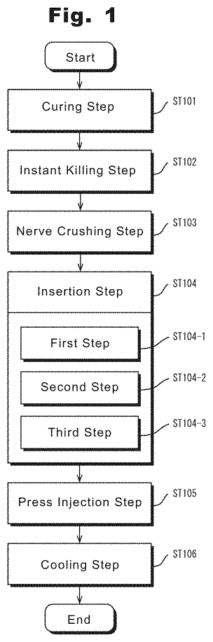

As shown in FIG. 1, the bleeding method for fish according to one embodiment of the present invention comprises curing step ST101, instant killing (Ikejime) step ST102, nerve crushing step ST103, insertion step ST104, press injection step ST105, and cooling step ST106. This fish bleeding method is available to a wide range of fish in general, and is particularly suitable for use with farmed fish such as red sea bream, greater amberjack, yellowtails including small yellowtails, large yellowtails and Japanese amberjack. An example in which the fish bleeding method according to the present invention is applied to yellowtail B1 is described below with reference to FIGS. 1 to 9. The instant killing step is so called “Ikejime” in Japanese. The step means to kill a fish, which is alive, instantly to maintain the freshness after the step.

### <Yellowtails (Large Yellowtail) B1>

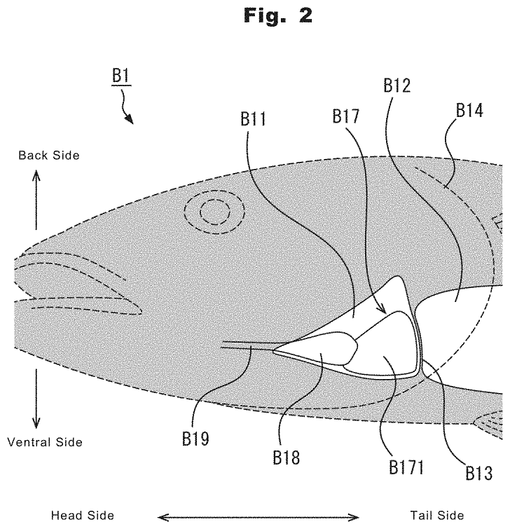

Here, an embodiment in which the fish bleeding method according to the present invention is applied to yellowtail B1 is described. As shown in FIG. 2, pericardial cavity B11, which is a body cavity containing heart B17, exists behind gill cover B14 of yellowtail B1. This pericardial cavity B11 is isolated by thin diaphragm B13 from abdominal cavity B12, which is a body cavity containing organs of the digestive system. In addition, FIG. 2 schematically represents the internal structure around the head of yellowtail B1 with a solid line. The appearance of yellowtail B1 is schematically represented with dashed lines. Body cavities relevant to the present invention are shown in white.

### <Curing Step ST101>

Curing step ST101 is a step in which yellowtail B1 is allowed to swim in water with an increased dissolved oxygen concentration for a certain period. This process increases the Umami flavor of the fish.

Specifically, it is understood that fish produces an energy substance called adenosine triphosphate (ATP) from oxygen and nutrients, and this ATP is converted into inosine, one of the Umami components, after death of the fish. In other words, it is said that fish that have a large amount of ATP contain more Umami components and create a stronger Umami taste. Therefore, it is desirable for the bleeding treatment that fish can retain more ATP after the bleeding treatment. In this regard, curing step ST101 has the effect of increasing the ATP possessed by the fish by causing/allowing the fish to swim in water with an increased dissolved oxygen concentration for a certain period, that is, in an environment where the fish easily produces ATP.

Furthermore, when fish exercise, it consumes ATP, which is an energy substance (move muscles). The more fish exercises, the less ATP that the fish possesses becomes. As a result, the Umami component of the fish reduces, and the Umami is weakened. In this regard, in curing step ST101, the fish is allowed to swim in water with an increased dissolved oxygen concentration for a certain period, the fish relaxes (does not exercise vigorously), thereby reducing ATP consumption. As a result, curing step ST101 has the effect of increasing the ATP possessed by fish.

Furthermore, the blood vessels of the fish relaxed by curing step ST101 are widened, making it easier for the blood to flow so that the blood of the fish is removed more efficiently.

The water in which yellowtail B1 swims in curing step ST101 is not particularly limited, but seawater having a dissolved oxygen concentration of 6 to 10 mg/L and an air saturation rate of 80 to 100% is preferable. Also, the period for which the fish are allowed to swim is not particularly limited, but it is preferably 180 minutes or longer.

### <Instant Killing Step ST102>

Instant killing step ST102 is a step in which a pick is inserted between the eyebrows of the fish to break the brain (i.e., kill the fish).

As described above, organisms including fish consume ATP to exercise (move muscles), so destroying the brain of fish in instant killing step ST102 makes it difficult for the fish to move muscles or convulse while subsequent steps, thereby reducing the consumption of ATP. That is, by this process, it is possible to allow the fish to possess more Umami components and strong Umami.

Incidentally, the process or way of instant killing step ST102 is not limited to the above-described embodiment.

### <Nerve Crushing Step ST103>

Nerve crushing step ST103 is a step in which a wire is inserted along the spine of the fish to crush the spinal cord of fish. For the same reason as in instant killing step ST102, crushing the spinal cord of fish in nerve crushing step ST103 makes it difficult for the fish to use muscles in subsequent steps, thereby reducing ATP consumption. That is, by this step, it is possible to allow the fish to possess more Umami components and strong Umami. This step also has the effect of preventing the body temperature of fish from rising and suppressing quality deterioration.

The process or way of nerve crushing step ST103 is not limited to the above-described step or method.

<Insertion step ST104>

As shown in FIG. 1, insertion step ST104 includes first step ST104-1, second step ST104-2 and third step ST104-3.

### <<First Step ST104-1>>

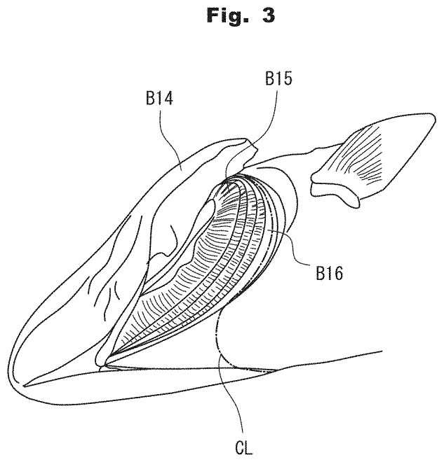

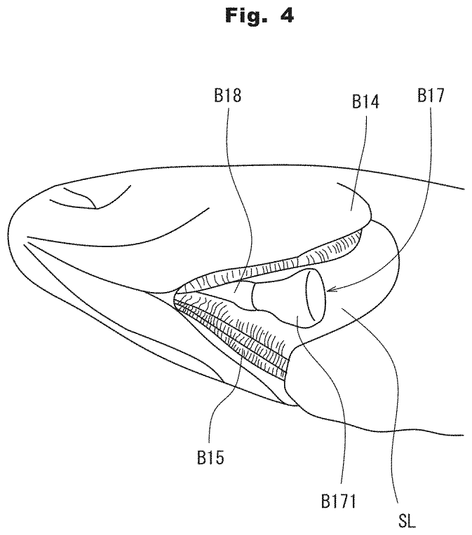

In first step ST104-1, the head and abdomen of yellowtail B1 are cut along the outer edges of gills B15. Specifically, gill cover B14 is lifted, and membrane B16, which is under gill B15, is cut away along cutting line CL indicated by the dashed line in FIG. 3, and the meat portion connecting the head and abdomen of yellowtail B1 is separated. Specifically, the meat portion connecting the head and abdomen of yellowtail B1 means the ventral portion (abdomen side portion) of the pericardial cavity B11 shown in FIG.2. As a result, as shown in FIG. 4, slit SL communicating between the pericentral cavity B11 and the outside of the fish body is formed. Formed slit SL is desirably widened so that the caudal side of ventricle B171 of heart B17 is exposed.

It is necessary to be careful not to do “Tomozure (mistakenly pull out bulbus arteriosus B18 when cutting a meat portion/flesh of yellowtail B1). Pulling out the bulbus arteriosus B18 is caused by inserting a knife in a position that is shifting toward a head side with respect to pericardial chamber B11, and by cutting abdominal aorta B19 shown in FIG. 2 together with a meat portion. When the meat portion at the abdomen side is pulled up to widen slit SL, the meat portion is pulled up in a state where bulbus arteriosus B18 is attached to the inner side of the meat portion. This state/condition is referred to as “Tomozure” of bulbus arteriosus B18. In this state, even if an injection liquid is pressure injected into the blood vessel system in pressure injection step ST105, which is described later, the liquid will leak out from the cut portion, and the pressure will not be transmitted further. As a result, most of the blood is not replaced with the liquid, and the bleeding (blood removing) is performed sufficiently.

In addition, it is preferred that the cutting of the meat portion of the yellowtail B1 is made such that a connecting portion (internal side of the fish body), which is made by connecting pericardial cavity B11 to slit SL, is located close to the head side rather than that tail side with respect to diaphragm B13. In other words, the connecting portion is located between the head and the diaphragm B13. With this cutting method, even if the connecting portion between slit SL and the outside of fish (the surface side of fish body) is not on the head side rather than diaphragm B13, the body cavity communicating with the outside of the fish body via slit SL is limited to pericardial cavity B11. As a result, the internal organs in abdominal cavity B12, which is a body cavity isolated from pericardial cavity B11, are not exposed to the outside air (or atmosphere). Thanks to this feature, the remaining steps are carried out while preferably maintaining the round body state of fish (not opening body state).

### <<Second Step ST104-2>>

In the second step, an injection needle (corresponding to an example of a “tubular device” in the claims) is inserted into heart B17 through slit SL.

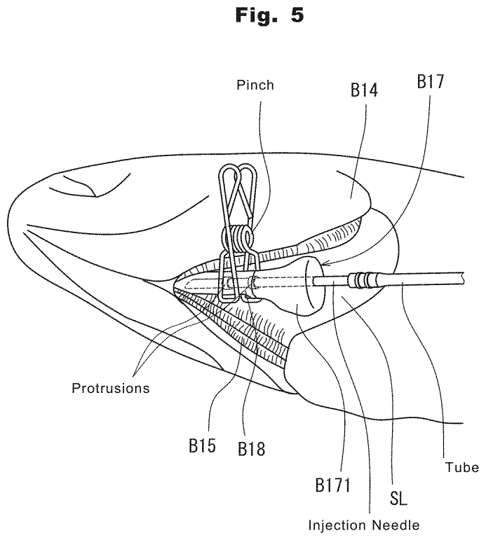

The injection needle is inserted into heart B17 from the caudal side of ventricle B171 toward bulbus arteriosus B18. As indicated by the dashed line in FIG. 5, the depth of injection is such that the projection reaches an inside of bulbus arteriosus B18. At this time, it is necessary to be careful not to pierce any portions other than an insertion port with the tip of the injection needle. As long as the injection needle is inserted in the same direction as a direction from the caudal side of ventricle B171 toward bulbus arteriosus B18, the insertion port may be placed at any location other than the caudal side of ventricle B 171.

### <<Third Step ST104-3>>

In the third step, the injection needle is fixed to heart B17. Specifically, as shown in FIG. 5, a portion of bulbus arteriosus B18 where the injection needle is inserted is sandwiched (pinched) by pinches.

At this time, it is desirable that a position between two protrusions of the injection needle is sandwiched by the pinches. As a result, even if a force is applied in the longitudinal direction of the injection needle, the protrusion and the pinch(es) are engaged so that the injection needle does not slip (or is not pulled) out of heart B17. As shown in FIG. 5 the injection needle has a pair of protrusions at a position closed to the tip. The protrusions have a round shape surrounding a circumference of the needle, which are separated along a longitudinal direction of the needle with a predetermined interval. At the protrusions, the diameter of the needles is larger than the other portions. In the embodiment in FIG.5, the interval is substantially the same as the pinche's width or slightly wider than the pinche's width.

Insertion step ST104 is not limited to the process or manner described above. The above described embodiment is a method of handling yellowtail B1 relatively carefully, however the fish bleeding method according to the present invention is designed to remove blood more reliably while suppressing damage to the muscle tissues of fish thanks to press injection step ST105 described later compared to the conventional fish bleeding method. As a result, even if insertion step ST104 is performed relatively roughly, sufficient effects is obtained. Specifically, the cutting method for yellowtail B1 and the position and direction of inserting the injection needle are changeable. First step ST104-1 and third step ST104-3 may be omitted, and the injection needle may be inserted without cutting yellowtail B1. In other words, insertion step ST104 can be executed as long as a tubular device is inserted into the blood vessel systems of yellowtail B1 so that the injection liquid can be press injected into the blood vessel system of yellowtail B1 in press injection step ST105 described later. Other aspects can be modified within the scope of the general skills possessed by engineers/designers.

### <Press Injection Step ST105>

Press injection step ST105 is a step of injecting the injection liquid into the blood vessel system of yellowtail B1 while applying a pressure to the liquid through the injection needle. The injection liquid is injected into yellowtail B1 at a flow rate of 2 L/min. As a result, the pressure in the blood vessel system of yellowtail B1 increases, and blood is discharged mainly from a gap of the insertion port, which is opened in ventricle B171 of heart B17 by the injection needle, and fragile portions of the capillary of gill B15. About 3 minutes after the start of the injection, the discharged liquid from the fish became substantially colorless, confirming that the blood in the blood vessel system was replaced with the injection liquid.

The injection liquid used in press injection step ST105 is a liquid containing fine bubbles, and reliably replaced with the blood while suppressing damage to the muscle tissue of fish (details will be described later).

Press injection step ST105 is not limited to the process or manner described above. It is possible to appropriately modify the flow rate of the injection liquid, the time/period for injecting the injection liquid, and the like.

### <Cooling Step ST106>

Cooling step ST106 is a step of cooling such that a core temperature of yellowtail B1 reaches about 5 degrees Celsius (or 41 Fahrenheit). For example, if the fish is a round shape (whole fish), the fish is cooled in ice water (0 to 5° C.) for about 30 minutes after the press injection step ST105. After that, immediately packing the fish in a container filled with ice, and putting ice on the fish to maintain the temperature in the container at about 5 degrees Celsius. By these cooling treatments, the core temperature of the fish becomes about 5 degrees Celsius after about 30 minutes. In addition, if the fish is in a cut state such as a fillet or a loin, the fish is cooled in ice water (0 to 5° C.) for about 30 minutes after the press injection step ST105 and then vacuum-packaged. After that, the fish is cooled again with ice water (0 to 5° C.) for about 30 minutes. As explained above, the core temperature of the fish becomes about 5 degrees Celsius by cooling for total about 60 minutes at temperature 0 to 5° C.

Cooling step ST106 maintains the freshness of yellowtail B1 by delaying rigor mortis of yellowtail B1, and also suppresses the propagation of bacteria and the like. As a result, cooling step ST106 prevents quality deterioration.

Cooling step ST106 is not limited to the step/method described above, and the cooling temperature, cooling time, cooling method, and the like are changeable within the scope of the general skills possessed by engineers/designers.

### [Injection Liquid]

The injection liquid is a liquid containing fine bubbles, and is press injected into the blood vessel system of yellowtail B1 in aforementioned press injection step ST105.

A liquid (or liquids) that is a source of the injection liquid is not particularly limited, and for example, sterilized seawater or physiological saline can be used. Further, if a liquid mixed with a gas such as carbonated water is used, the process of mixing the gas can be omitted when generating fine bubbles. In addition, various components can be added to the injection liquid (details will be described later). Additionally, the gas forming the fine bubbles may be nitrogen gas, carbon dioxide gas, or mixed gas of nitrogen gas and carbon dioxide gas other than air. By not including oxygen in the components of the fine bubbles, it is possible to prevent the lipid oxidation of fish meat and the metification of the myoglobin pigment due to gas components contained in the injection liquid.

### <About Fine Bubbles>

Here, fine bubbles are bubbles having a diameter of less than 100 μm, and are standardized by International Organization for Standardization (ISO). Furthermore, among fine bubbles, bubbles with a diameter of 1 μm or more and less than 100 μm are defined as microbubbles, and bubbles with a diameter of less than 1 μm are defined as ultrafine bubbles. Bubbles generally called nanobubbles (not a term standardized by ISO) belong to the ultrafine bubbles. Methods for generating fine bubbles include, for example, swirling liquid flow style, static mixer style, fine hole style, ejector style, venturi style, pressurized dissolution style (reduced pressure precipitation), cooling dissolution style (heat precipitation) and mixing vapor condensation style. Any styles may be used for generating the injection liquid used in the fish bleeding method according to the present invention.

In this embodiment, fine bubbles are generated using a fine bubble generator. Using the fine bubble generator, for example, over 20 to 60 minutes, fine bubbles containing carbon dioxide as a component are generated until the bubbles are saturated. The component of the fine bubbles is arbitrary, and the above carbon dioxide is an example. When the fine bubbles reach saturation, the concentration of oxygen dissolved in water is maintained at a constant value. By confirming that the oxygen concentration is stabilized at a constant value in this manner, it can be determined that the fine bubbles have reached saturation. For example, at 15 degrees Celsius, the oxygen concentration in the bubble injected water is 5.0 to 6.0 mg/L if fine bubbles are not generated. On the other hand, when the amount of fine bubbles generated increases, the oxygen concentration decreases. After that, even when the fine bubbles are continuously generated, the oxygen concentration stabilizes at 0.05 mg/L. The density of fine bubbles in the saturated state is estimated to be 5.0×10⁸ to 2.0×10⁹/mL at 0 to 25 degrees Celsius.

### <Effect(s) of Injection Liquid>

### <<Sensory Test>>

In order to examine and evaluate the effect(s) of the injection liquid according to the present invention, yellowtails A to E were treated with different treatment methods were subjected under sensory tests to determine degrees of odor and degrees of Umami. The tests were conducted after 8 hours, 12 hours, 24 hours and 30 hours from the treatments.

### <Subjects of Sensory Tests>

Yellowtail A: A yellowtail that underwent only the processes up to nerve crushing steps ST103 (without bleeding) from ST101.

Yellowtail B: A yellowtail for which injection step ST105 was performed using seawater (not containing fine bubbles) instead of the injection liquid.

Yellowtail C: A yellowtail that was subjected to the press injection step ST105 using carbonated water (not containing fine bubbles) instead of the injection liquid.

Yellowtail D: A yellowtail that was subjected to injection step ST105 using an injection liquid produced from sterilized seawater. The fine bubbles in the injected liquid consist of air contained in seawater

Yellowtail E: A yellowtail that was subjected to injection step ST105 using an injection liquid produced from carbonated water. The fine bubbles in the injection liquid consist of carbon dioxide contained in the carbonated water.

### (Degrees of Odor)

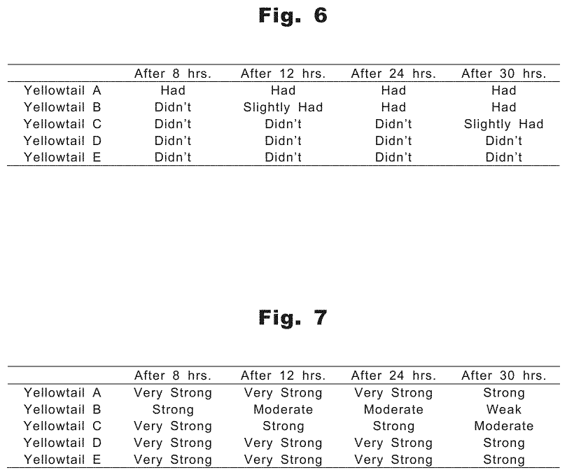

FIG. 6 shows the results of the sensory test with respect to the degrees of odor.

Specifically, yellowtail A had an odor regardless of the passage of time (Had in FIG. 6). Whereas yellowtail D and yellowtail E did not have an odor regardless of the passage of time (Didn't in FIG. 6). Also, yellowtail B and yellowtail C had no odor at first, but yellowtail B had an odor 12 hours after the treatment and yellowtail C had an odor 30 hours after the treatment (Slightly Had first, then turned to Had in FIG. 6).

### (Degrees of Umami)

FIG. 7 shows the results of the sensory test on the degrees of Umami.

Specifically, yellowtail A, yellowtail D and yellowtail E had a strong Umami flavor regardless of the passage of time. In addition, yellowtail B and yellowtail C had a strong Umami taste at first, but yellowtail B became weaker 12 hours after the treatment and yellowtail C became weaker 30 hours after the treatment.

### <<Mechanism of Effect of Injection Liquid>>

From the above results, it is understood that the injection liquid according to the present invention has the effect of suppressing odor and enhancing Umami regardless of the passage of time (or over time). The mechanism that creates these effects is described below

### (Mechanism of Suppressing Odor)

It is generally said that blood is the cause of odor of fish. Specifically, fish blood contains a component called dimethylamine, and microbes adhering to the fish proliferate while decomposing dimethylamine after the fish dies, thereby generating trimethylamine. This trimethylamine is responsible for the odor of fish. In the sensory test, yellowtail A that was not subject to the bleeding process was confirmed to have an odor regardless of the passage of time. On the other hand, yellowtails B to E that were subject to the bleeding process had no odor at the point of time after 8 hours from the treatment. The difference in the above results is due to the presence or absence of trimethylamine.

Furthermore, yellowtail B and yellowtail C developed an odor as time passed after the treatment. On the other hand, yellowtail D and yellowtail E did not develop any odor regardless of the passage of time. This result is considered due to the difference in accuracy of the bleeding treatment (or degrees how thoroughly the blood was removed).

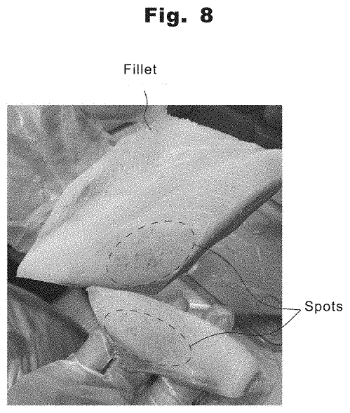

For example, yellowtail fillets such as yellowtail B and yellowtail C, which are subjected to a bleeding treatment by a conventional method of injecting a liquid that does not contain fine bubbles, have spots as shown in FIG. 8. This is probably because the blood remaining in the capillaries appeared on the surface of the fillets. Thus, blood may not be completely discharged or removed in the bleeding treatment in which a liquid that does not contain fine bubbles is injected. It is understood that yellowtail B and yellowtail C developed an odor after a certain period of time from the treatment due to the remaining blood without being discharged.

On the other hand, when the bleeding treatment is performed using the injection liquid according to the present invention, the fine bubbles contained in the injection liquid enter the capillaries and the blood is completely discharged without blood remaining. Therefore, it is considered that the odor did not occur even after a long time had passed since the treatment.

### (Regarding Mechanism Not Weakening Umami)

When the conventional method (yellowtail B, yellowtail C) is used for bleeding in order to suppress the odor, there is a problem that the Umami is weakened. This is probably because the muscle tissues are destroyed or damaged by the conventional bleeding treatment, and ATP flowed out (for the relationship between ATP and Umami, see

### <Curing Step ST101>)

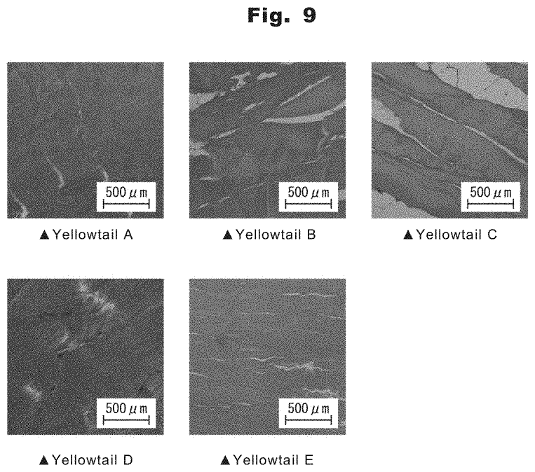

FIG. 9 is photographs of fematoxylin and eosin-stained muscle tissue of yellowtail A to yellowtail E taken at 70 time magnification. For example, in the sensory test, yellowtail B and yellowtail C, which had a strong Umami taste at first and weakened over time, had their muscle tissues (indicated by dark gray) that were peeled off and crevices (the portions shown in gray) are largely created in their muscle tissues. From the picture above, it was confirmed that the muscle tissue has been destroyed or damaged.

Furthermore, yellowtail A, which was found to have a strong Umami taste over time in the sensory test, had muscle tissue that were densely packed and have few crevices (gaps). This is because yellowtail A was not treated for bleeding and the muscle tissue has not been destroyed.

On the other hand, yellowtail D and yellowtail E, which were subjected under the fish bleeding treatment according to the present invention, were found to have a strong Umami taste regardless of the passage of time in the sensory test. Moreover, according to FIG. 9, the muscle tissues of yellowtail D and yellowtail E were hardly destroyed or damaged, and there were few gaps. That is, when the injection liquid according to the present invention was press injected, the damage to the muscle tissue was suppressed. This is probably because the fine bubbles contained in the liquid lowered the viscosity of the blood.

Specifically, red blood cells contained in blood are negatively charged, and fine bubbles are also said to have negatively charged surfaces. When an injection fluid containing fine bubbles is injected into the blood, a repulsive force acts between the red blood cells and the fine bubbles, preventing aggregation of the red blood cells and reducing the viscosity of the blood. Even if the flow rate or water pressure of the injecting fluid is lowered, or the time period for injecting the injecting fluid is shortened, the bleeding treatment is sufficiently performed. As a result, the damage to the muscle tissues is suppressed.

It is noted that fine bubbles are well-known as a cleaning technique. However, the mechanism that enhances cleansing effect is completely different from the mechanism that enhances Umami. Specifically, since dirt (such as oily dirt) that is expected to be effectively cleaned using fine bubbles is positively charged, an attractive force acts between the dirt and the fine bubbles. By attracting a large number of fine bubbles to the dirt, the overall buoyancy increases and the dirt floats, making it easier to remove the dirt (on the other hand, one fine bubble has a very small volume, so the buoyancy is also small). That is, for those skilled in the art, there is no motivation to apply the cleaning technique using fine bubbles to conventional bleeding methods for fish, and the fish bleeding method according to the present invention is not an invention that those skilled in the art could have easily conceived.

### <Containing Ingredients>

The following food additives can be appropriately added to the injection liquid:

Antioxidants that suppress deterioration and discoloration due to oxidation;

Anticoagulants that prevent vasoconstriction and ensure smooth flow of injection fluid into blood vessels, including capillaries;

Washing soap;

Fungicide;

A fragrance that suppresses the fishy smell peculiar to fish meat,

Nutritional supplements; and

Seasonings such as Umami ingredients and sweeteners.

See Japanese Patent Publication: JP-A-2019-122292 [0022] to [0027], JP-A-9-149761 [0019].

Additives derived from natural raw materials include, for example, citrus fruits (mandarin orange, yuzu, sudachi, kabosu, orange, lemon, lime, grapefruit, etc.);); herbal (eg, peppermint, spearmint, perilla, rosemary, sage, tea tree, etc.) extracts as antioxidants, flavors, fruit juices, and nutritional supplements. In addition, seaweed extracts are rich in dietary fibers such as sodium alginate, carrageenan, and fucoidan, along with glutamic acid, which is an Umami component. Therefore, seaweed extracts can be formulated as nutritional supplements and seasonings.

In addition, other components that are considered to be blended into the injection liquid are exemplified below.

Antioxidants: antioxidant vitamins such as vitamin C (ascorbic acid) and vitamin E (α-tocopherol);

Antioxidant polyphenols such as epigallocatechin gallate, catechin, epicatechin, epigallocatechin, epicatechin gallate, quercetin, esperidin, pterostilbene, proanthocyanidins, and carnosic acid;

Antioxidant carotenoids such as beta-carotene, vitamin A, lycopene, lutein, and astaxanthin;

Antioxidant peptides such as glutathione

Antioxidant sugars such as isomaltulose;

Antioxidants such as isomaltulose sugars;

Synthetic antioxidants such as butylated hydroxyanisole

Others, such as uric acid, melatonin, and urobilinogen.

Fragrances: citral, piperidine, pyrazine, terpene hydrocarbons, isothiocyanates, etc.

Nutritional supplement . . .

Essential fatty acids such as docosahexaenoic acid, eicosapentaenoic acid, alpha-linolenic acid, arachidonic acid, gamma-linolenic acid;

Vitamins such as vitamin A, vitamin B, vitamin C, vitamin D, vitamin E, vitamin H, vitamin K, vitamin P, vitamin U, cobalamin;

Minerals such as zinc, iron, copper, chromium, selenium, magnesium, calcium, potassium, sodium, cobalt, molybdenum;

Amino acids such as tryptophan, threonine, leucine, isoleucine, lysine, methionine, phenylalanine, histidine, asparagine, serine, proline, glutamine, tyrosine, y-aminobutyric acid, taurine, etc.

Seasonings:

Typical household seasonings such as sugar, salt, vinegar, soy sauce, sake, mirin (sweetened cooking liquor);

Umami components such as glutamic acid, inosinic acid, guanylic acid;

Sweeteners such as xylitol and saccharin.

Anticoagulants: sodium citrate, etc.

Cleaning agent: strong alkaline electrolyzed alkaline water, etc.

Bactericide: strongly acidic electrolyzed acidic water, etc.

When strongly acidic electrolyzed acidic water is used, which is a disinfectant, the present invention may be carried out in a state of being immersed in the strongly alkaline electrolyzed alkaline water. As a result, the dense and complicated structure constituting the gills is sufficiently exposed to the electrolyzed acidic water and sufficiently sterilized. Also, strong alkaline electrolyzed alkaline water may be injected into the heart or blood vessels of fresh fish before the electrolyzed acidic water, which is a sterilizing agent, is injected into the heart or blood vessels of the fresh fish. As a result, the inside of the blood vessels of the fresh fish is sufficiently washed with the electrolyzed alkaline water, and the bactericidal action of the electrolyzed acidic water is further enhanced. Furthermore, it is possible to almost completely remove the odor caused by the blood remaining in the blood vessels of the fresh fish (see JP Patent Application Publication 2005-151875, paragraphs [0009] to [0014]).

Furthermore, liquids in which hydrogen or oxygen are dissolved or dispersed may be used in the practice of the present invention. In the case of hydrogen, hydrogen is dissolved or dispersed so that the liquid hydrogen concentration is in the range of 0.7 to 1.6 mg/L. As a result, hydrogen, which is an excellent reducing agent, spreads throughout the vasculature of the fish, suppressing oxidation of the tissue inside the fish, and further enhancing the freshness retention of the fish. When oxygen is used, rigor mortis is delayed and the production of lactic acid is suppressed by making the oxygen concentration of the liquid to be injected higher than the blood oxygen concentration of the fresh fish (raw fish). As a result, it is possible to further improve the freshness retention of fish (JP Patent Application Publication: 2010-104356, see paragraph [0048]).

### [Fish After Bleeding Treatment]

The fish after the bleeding treatment according to the present invention is a fish in which the blood in the blood vessel system is replaced with the injection fluid, and the blood vessel system is filled with the injection fluid. However, the injection liquid may have a reduced amount of fine bubbles from the beginning.

According to the fish bleeding method according to the present invention, the blood of fish is more reliably removed from the fish after the bleeding treatment while suppressing damage to the muscle tissue of the fish. Accordingly, Umami increases and ode decreases.

### [Fish Bleeding Apparatus 1]

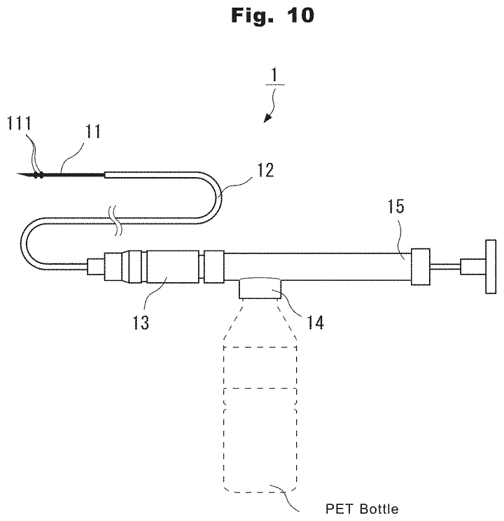

As shown in FIG. 10, fish bleeding apparatus 1 according to one embodiment of the present invention includes injection needle 11 (corresponding to an example of a “tubular device” in the claims), tube 12, fine bubble generation part 13, container connection part 14, and pressure pump 15 (corresponding to an example of a “pressure part” in the claims). Fish bleeding device 1 is an embodiment in which the fish bleeding method according to the present invention is easily carried out, and since the device is portable, the bleeding treatment is performed immediately at a place where fishes are caught.

### <Injection Needle 11>

Injection needle 11 is a member to be inserted into the blood vessel system of fish, and is a member for supplying the liquid containing fine bubbles into the blood vessel system of fish. A method of inserting injection needle 11 is as described in <Insertion Step ST104>. Further, injection needle 11 has two protrusions 111. For example, by pinching a portion between the two protrusions 111, injection needle 11 is fixed to the fish.

The shape, material, mode of injection needle 11 are not particularly limited.

### <Tube 12>

Tube 12 is a member that indirectly connects injection needle 11 to fine bubble generation part 13, and that supplies a liquid containing fine bubbles through injection needle 11 into the blood vessel system of fish.

The form or shape of tube 12 is not particularly limited.

Further, tube 12 is not necessarily required in fish bleeding apparatus 1. For example, injection needle 11 and fine bubble generation part 13 may be directly connected.

<Fine Bubble Generation part 13>

Fine bubble generation part 13 generates fine bubbles by a swirling liquid flow method. The liquid that has passed through fine bubble generation part 13 becomes a liquid (injection liquid) containing the fine bubbles generated by fine bubble generation part 13, and is injected into the blood vessel system of fish through injection needle 11 and tube 12.

Fine bubble generation part 13 is a type of fine bubble generation part that does not have an injection port for injecting gas so that fish bleeding apparatus 1 becomes compact. Fine bubble generation part 13 uses gas contained in the liquid to generate fine bubbles. Therefore, by using a liquid such as carbonated water in which a gas has been mixed in advance, more fine bubbles are generated.

The form or shape of fine bubble generation part 13 is not limited to the one described above, and may have an injection port for injecting gas. In this case, it is possible to adjust the amount of fine bubbles by adjusting the injection amount of the gas. Further, the method for generating fine bubbles is not limited to the swirling liquid flow method.

### <Container Connection Part 14>

Container connection part 14 is a member that connects a PET bottle containing a liquid to the device, and has a female screw threadedly engaged with a male screw provided on the opening of the PET bottle. As a result, fish bleeding apparatus 1 easily performs fish bleeding process by using a commercially available PET bottle beverage so that a liquid in the PET bottle is to be injected. In addition, various effects are obtained by changing the PET bottle drink to be used. For example, if carbonated water is used, more fine bubbles are generated. If lemon flavored drinking water is used, the fish is also flavored with lemon.

The form of container connection part 14 is not limited to the above-described one, and for example, it may be configured so that a container other than a PET bottle can be attached. Container connection part 14 may be configured to be connectable to a water faucet. Alternatively, the containers (or bottles) may be of a so-called cartridge type. In the cartridge type, plurality of containers containing different liquids are prepared in advance, and the containers can be used repeatedly simply by replacing the containers. Each container accommodates different liquids in which the components to be blended and the type and amount of contained gas are adjusted.

### <Pressure Pump 15>

Pressure pump 15 is a member that applies a pressure to inside of a PET bottle so that the liquid in the PET bottle is forced into fine bubble generation part 13. The liquid pressurized into fine bubble generation part 13 becomes the pressurized injection liquid as described above, and is inserted into the blood vessel system of fish via injection needle 11 and tube 12

The “pressure part” in the claims is not limited to an embodiment of pressure pump 15 as long as it can insert the injection liquid into the blood vessel system of fish. For example, a compressor may be used to apply pressure, or it may be directly connected to a water faucet and the water pressure may be used to force the injection liquid into the blood vessel system of fish. The embodiment(s) using pressure pump 15 is superior in that it is easier to carry. On the other hand, the embodiment(s) using a compressor is excellent in that the pressure can be adjusted. The embodiment using water supply has the advantage of reducing production costs by using existing parts (or reducing the number of parts).

[Effects/Advantages of Fish Bleeding Method, Production Method for Fish after Bleeding Treatment, Fish after Bleeding Treatment, and Fish Bleeding Apparatus 1 according to the Present Invention]

As described above, according to the fish bleeding method, production method for fish after bleeding treatment, fish after bleeding treatment, and fish bleeding apparatus 1, by using the injection liquid, which is a liquid containing fine bubbles, it becomes possible to bleed blood more reliably while suppressing damage to tissues. As a result, the odor of fish is suppressed without weakening the Umami of fish. In addition, the fish after the bleeding treatment according to the present invention has a strong Umami taste and less odor because the blood is more reliably removed while suppressing damage to the muscle tissue of fish by the bleeding treatment method for fish according to the present invention.

Further, fish bleeding apparatus 1 is one embodiment in which the fish bleeding method according to the present invention is easily carried out. Since the device is portable, the bleeding treatment is performed immediately at a site where the fish are caught

### REFERENCES

1 . . . Fish bleeding device
11 . . . Injection needle
111 . . . Protrusion
12 . . . Tube
13 . . . Fine bubble generation part
14 . . . Container connection part
15 . . . Pressure pump
B1 . . . Yellowtail
B11 . . . Peritoneal cavity
B12 . . . Peritoneal cavity
B13 . . . Diaphragm
B14 . . . Gill lid
B15 . . . Gills
B16 . . . Membrane
B17 . . . Heart
B171 . . . Ventricle
B18 . . . Bulb artery
B19 . . . Abdominal aorta
CL . . . Cutting line
SL . . . Slit

What is claimed is:

1. A fish bleeding method, comprising:
an insertion step of inserting a tubular device, which is a member in a tubular shape, into a blood vessel system of a fish, and
an injection step of injecting an injection liquid, which is a liquid containing fine bubbles, into the blood vessel system of the fish through the tubular device that is inserted in the insertion step.

2. The fish bleeding method of claim 1, further comprising:
a fine bubble generation step of generating the injection liquid wherein the fine bubbles are saturated in the injection liquid during the fine bubble generation step.

3. The fish bleeding method of claim 1, further comprising:
a curing step of allowing the fish to swim in a curing liquid, which is a liquid in which oxygen is dissolved, before the insertion step.

4. The fish bleeding method of claim 1, wherein
a gas that is used to form the fine bubbles is any one of nitrogen gas, carbon dioxide gas, and a mixture of nitrogen gas and carbon dioxide gas.

5. A fish production method for producing a fish after a fish bleeding treatment, comprising:
an insertion step of inserting a tubular device, which is a member in a tubular shape, into a blood vessel system of a fish, and
an injection step of injecting an injection liquid, which is a liquid containing fine bubbles, into the blood vessel system of the fish through the tubular device that is inserted in the insertion step.

6. The fish production method of claim 5, further comprising:
a curing step of allowing the fish to swim in a curing liquid, which is a liquid in which oxygen is dissolved, before the insertion step.

7. A fish that is processed by a fish bleeding treatment, wherein
the fish has a puncture mark that is formed by inserting a tubular device, which is a member in a tubular shape, into a blood vessel system of the fish,
blood in the blood vessel system is replaced with an injection fluid that contains fine bubbles such that an inside of the blood vessel system is filled with the injection fluid.

8. A fish bleeding apparatus, comprising:
a tubular device, which is a member in a tubular shape, that is configured to be inserted into a blood vessel system of a fish,
a container connection part that is configured to directly or indirectly connect a container for containing liquid to the tubular device,
a fine bubble generation part that generates an injection liquid, which is a liquid containing fine bubbles, from the liquid contained in the container,
a pressure unit that applies pressure to the injection liquid in the container such that the injection liquid is forced into the blood vessel system of the fish through the tubular device.

9. The fish bleeding apparatus of claim 8, wherein
the container connection part has a female screw that is mate with a male screw provided on a mouth of a polyethylene terephthalate (PET) bottle.
